(19) United States
(12) Patent Application Publication
(10) Pub. No.: US 2024/0119824 A1
(43) Pub. Date: Apr. 11, 2024

(54) System and Method for Supporting Voters

(71) Applicant: Robert Francis Bodi, Westlake, OH (US)

(72) Inventor: Robert Francis Bodi, Westlake, OH (US)

(21) Appl. No.: 18/377,212

(22) Filed: Oct. 5, 2023

Related U.S. Application Data
(60) Provisional application No. 63/414,224, filed on Oct. 7, 2022.
(60) Provisional application No. 63/434,236, filed on Dec. 21, 2022.

(51) Int. Cl. G08B 21/24

(52) U.S. Cl. CPC G08B 21/24

(57) ABSTRACT

A voter support system and method for supporting voters who may want to vote for a particular party, slate of candidates, or particular types of candidates is disclosed. The system collects information from various data sources including public, private, candidate, and political party data sources for consolidating into a presentation system comprising a voter mobile smart device running a specialized software voter application. One or more remote servers and/or databases may be provided by the system to consolidate various data, compile the data into useful information, and communicate that data to the voter smart device via the installed voter application. Such a system can inform voters of candidates and issues in upcoming elections and help the voter vote in the election in a proper and efficient manner.

### CROSS-REFERENCES TO RELATED APPLICATIONS

This application claims the benefit of U.S. provisional patent application Ser. No. 63/414,224 filed on Oct. 7, 2022, and U.S. provisional patent application Ser. No. 63/434,236 filed on Dec. 21, 2022, both incorporated herein by reference.

### BACKGROUND

Voters often seek guidance in determining which candidates to vote for in an election for public office. Voters often don't have the time to research the positions of individual candidates on important issues, and hence don't know which candidates support their views and which do not. Voters may not know which candidates are running for which offices, and they may not know which offices are up for election in any given election season. Furthermore, many voters belong to a particular political party, and they may want to vote “for the ticket” by voting for all candidates of that particular party. Alternatively, voters may want to vote for candidates of any party who support their principles. Sometimes, the party of the candidates is listed on the ballot, but sometimes certain offices are non-partisan, and the political party of the candidate is not listed. Other times, more than one candidate for a particular party may be competing with each other on the ballot. A system and method for aiding voters in effectively participating in elections and choosing which candidates to vote for would be useful.

Furthermore, voters may forget whether they have applied for a vote-by-mail ballot (such as an absentee ballot), or they may forget to fill out and send their ballot to the election facilities. Some voters also may forget which day is election day, or where their polling location is located. In such situations, reminders can be provided to the voter to request a ballot, return a ballot, or that they need go to a particular polling place to vote that day within the voting window. Again, a system and method for solving these problems and reminding voters to vote in their desired and chosen manner would also be useful.

In addition, candidates need a tool to help them canvas voter neighborhoods, and to target their efforts to voters who support the principles and positions of that candidate. Candidates need to know who tends to vote in particular elections, and focus their efforts on likely voters rather than people not likely to vote. A system and method for solving these problems of candidates would also be useful.

### SUMMARY

Provided is voter support system and method for supporting voters who may want to vote for a particular party, slate of candidates, or particular types of candidates is disclosed. The system collects information from various data sources including public, private, and political party data sources for consolidating into a presentation system comprising a smart device, such as a computer, tablet, or in particular a mobile device of the voter running a specialized software voter application that has been installed on the device. One or more remote servers and/or databases may be provided by the system to consolidate various data, compile the data into useful information, and communicate that data to the smart device via the installed voter application. In some embodiments, most or all of the functionality of the system may be provided by the remote device running the voting application, whereas in most practical applications, it is preferable to offload at least some of the processing and/or data storage to a remote server system which may include one or more computers and one or more databases.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 shows examples of the various entities that interact with the components of the example system.

FIG. 2 shows some example functions that the system can perform.

FIG. 3 shows example interactions of an example voter system with various external entities.

FIG. 4 is a flow chart showing one example process for reminding voters to vote in an election.

### DETAILED DESCRIPTION OF THE EXAMPLE EMBODIMENTS

A voter support system and method for supporting voters who may want to vote for a particular party, slate of candidates, or particular types of candidates is disclosed. The system can also support informing voters about candidates, levies, issues, and other ballot initiatives. The system can also provide tools to support candidate outreach to voters, including support in both identifying voters appropriate for that candidate to target, getting candidate information out to those voters, and soliciting donations and other support from such voters.

The system collects information from various data sources including public, private, commercial, and political party data sources for consolidating into a presentation system comprising a smart device (e.g., computer or a mobile device such as a cell phone, smart watch, tablet, etc.) of the voter running a specialized software voter application that has been installed on the device. Such installation can be at the request of an individual (e.g., candidate or a sponsor) or organization (e.g., political party, union, NGO, business, non-profit, or other organization), with such requests originating in marketing material(s) that might include QR codes or other types of links to installation routines.

One or more remote servers and/or databases may be provided by the system to consolidate various data, compile the data into useful information, and communicate that data to the smart device via the installed voter application. In some embodiments, most or all of the functionality of the system may be provided by the remote smart device running the voting application, whereas in most practical applications, it is preferable to offload at least some of the processing and/or data storage to a remote server system which may include one or more computers and one or more databases and which may be provided as a cloud-based service. There may be one common application for installation on smart devices, or there may be a voter application and a separate candidate application, or a plurality of specialized applications that work together.

Voter and candidate data is ubiquitous, since voter data is collected by election boards, political parties of the various states, unions, voter organizations, government bodies, NGOs, and businesses which, along with candidate information, is often made public or available by request or for purchase. Often, political parties and/or individual candidates use social media, phone calls, or postal services to notify voters of preferred candidates (and/or ballot issues), and to remind voters to request a vote-by-mail ballot and/or vote on election day or for early voting at a polling location. An automated method of performing such services by tracking voter voting status in particular elections and providing voters about the qualifications, positions, principles, background, status, and party membership of candidates would aid this process and help the voter ensure that his vote goes to the candidates of his choice, who support the voter's values and needs.

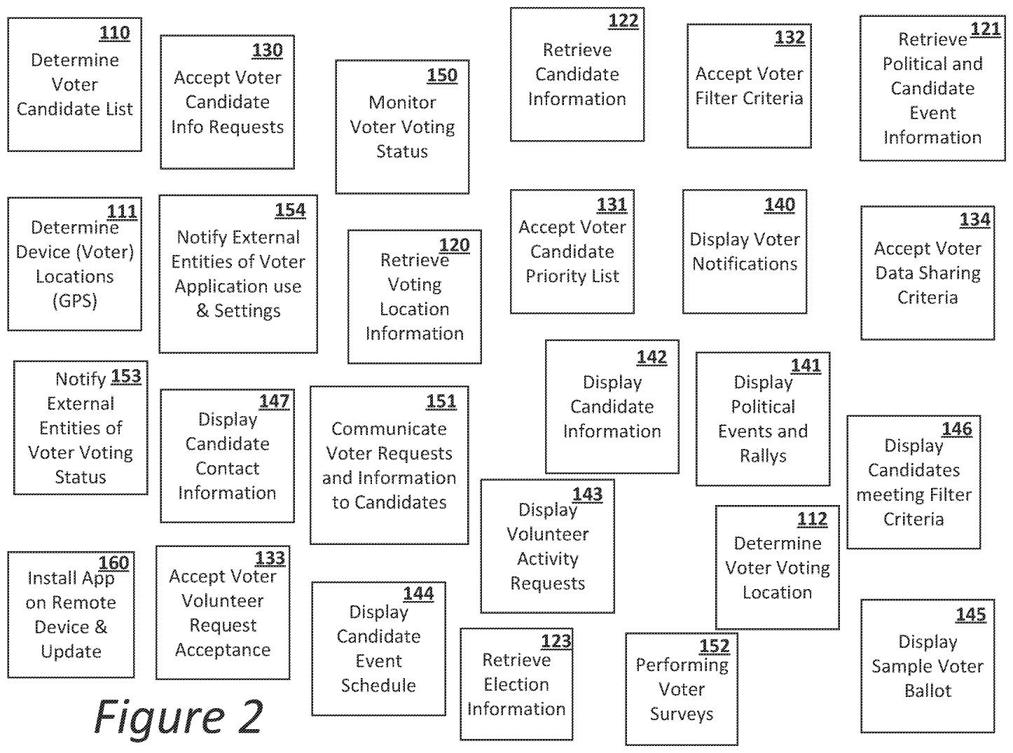

One effective means of performing some or all of these functions (some of which are shown in FIG. 2, discussed in detail hereinbelow) is to provide a voter software application that can be installed on a smart device, such as a computer, cell phone, smart phone, tablet, laptop, portable computer or other mobile device (device mobility is particularly useful), and that will interact with a specialized server system that can be centralized or distributed. A separate application for candidates might also be provided, or the applications can be combined into a single multi-function application. These applications for installation on user (voter and/or candidate devices) would use various features of the smart device be able to access data, provide directions, and track the location of the voter, such as by using a GPS device of the smart device, or by tracking the cell towers or other fixed communications facilities that are used by the smart device. The device would access and compile various public and private information and interact with the central server system to support user (voter) voting activities at many different levels and in many different ways. Some of the functionality can be centralized into a server system, but messaging, data collection, and user interfacing could all be provided by the smart device that is in possession of the user (e.g., voter and/or candidate).

For example, one potential function of the voter application will be to provide the voter with information about individual candidates and ballot issues for whom/which the voter can vote in an upcoming (particular) election. Such information can include, for example, disclosing the political party the candidate belongs to, the sex of the candidate, the marital and family status of the candidate, the religion of the candidate, past offices held by the candidate, the candidate's positions on particular issues of concern to the voter (such as positions on such issues as gun ownership, abortion, crime, taxation, spending, border security, national defense, police departments, etc.). Financial information such as fundraising amounts, expenses, and major donors, for example, can be disclosed to the voter. The voter might be provided with the ability to search for particular donors or donations. Many other matters that may be important to the candidate can be collected and provided to the voter, and information important to the campaigns or system sponsors can be collected from the users.

Links to candidate proposed policies, video biographies, position statements, endorsements, etc. can all be communicated to the voter. Photographs of the candidate, resumes, voting records, biographies, previous election histories, and other information can be provided to the voter. The system may provide the voter with means of communicating directly with the candidates, their campaigns, elected officials, political parties, political clubs and organizations, government agencies, etc. Such communication could include emailing, texting, or other types of messaging. The voter can request campaign signs, literature, and other materials from candidate campaigns or political parties or locations. Voters can get a list of events the candidate will be attending or hosting. Voters can get lists of clubs, unions, parties, businesses, or other organizations that align with particular candidates, political parties or other entities or interests.

Issues that are on the ballot for voter consideration can be listed, with links to information resources, endorsements or oppositions by various individuals and groups, and other resources that can help a voter determine how to vote on the issues. Such issues include proposed statutes or constitutional amendments, tax levies, charter issues, zoning matters, elected official recalls, etc.

Voter, candidate, election, and issue information can be collected from various sources, such as by data mining various public databases (e.g., voter information, election information, elected office information, government department information, and candidate information) and candidate reporting forms, from candidate surveys, from databases of governments at any level (e.g., from national, state, county, and local governments), from commercial databases (from which data may be purchased as desired), from private organizations such as unions, non-profit organizations, NGOs, public service organizations, data collection organizations, businesses, etc. The system may collect information directly from users via polling, focus groups, or collecting information obtained from the smart devices themselves.

The system can utilize the data capture functions of the smart device for collecting information that can be utilized by candidates or parties to support the party's candidates or oppose opposition candidates. For example, the user of the smart device might use it to take photographs or video (or collect audio) of a candidate at a candidate event, fundraiser, public event, or other location. The app can utilize, or manage, those functions and capture and forward that information to supported candidates or party databases, or it might be used for opposing candidates as well. The app can capture the time and location of the recording. If that candidate is a supported candidate, the candidate or the party can utilize the photos, video, or audio for promotional purposes. The candidate application may be provided to candidates to support these functions. For example, when a candidate attends a charity event, attendees could use the voter app running on the smart (e.g., mobile) device to capture the candidate, his/her speeches, and their interactions with attendees for later use in supporting the candidates. In contrast, such video could be used for opposition purposes. For example, capturing a candidate criticizing important leaders or the voter, making statements of supporting projects, activities, or having positions that the candidate refutes in public can be used to show hypocrisy on the part of the candidates. This collected information can also be used to aid various candidate support and/or opposition resources, such as websites, blogs, social media, etc. The system could automatically post materials collected by the voter and/or the candidate apps and other sources on websites, blogs, social media, news sites, or other locations to provide regular updates to these additional resources about candidates and campaigns.

The system can also data mine other sources of information about the candidates from various sources. For example, online news stories, social media posts, public activities (such as might be posted in third party websites or social media posts), can all be utilized by the system. Links to these resources can be used to disseminate this information to both voters and candidates, quotes (such as endorsements, etc.) can be used is press releases and on social media platforms or candidate websites, etc.

Since many users of the installed applications can attend many different events, this feature allows voters, candidates (and third parties) to capture much more information about the candidates and their opposition that can then be used as part of their campaign, or that might be used by the political party or third parties for support or opposition purposes. Since it can be difficult and costly for candidates to pay photographers or videographers to follow them to events, and even more difficult to monitor the activities of opposition candidates, this system along with the voter and candidate applications can be used to greatly expand potential access to the activities of the candidates.

The applications can utilize features of the smart device for the purpose of collecting this data, which can then be processed (such as correcting lighting or focus problems), tagged with metadata (which may use date, time, and location information obtained by the device to track where and when the video was obtained, and match to the known events of the candidate). This data can then be transmitted to the central server for further processing and integration into other communication efforts and activities, such as by creating and broadcasting newsletters, websites, newscasts, blogs, vlogs, podcasts, etc. In this way a vast amount of useful information can be collected from supported and opposed candidates that otherwise would not be available. In essence, the application allows users and candidates to “spy” on the activities of candidates or their opponents for capture and use in campaigning activities.

The data processing functions can utilize various known processes to correlate various data to achieve insight into voters and candidates. The use of artificial intelligence tools and methods can be used to identify voters who might support particular candidates or issues, even if the voter is of a different party than the candidate. Assessments of voter behavior can be done to determine whether a particular voter is a potential supporter or opponent of particular candidates and/or issues. Existing analysis tools and software could be utilized for such purposes.

Note that the application could use notices to request users who are at candidate events (which can be determined by monitoring candidate event schedules and the location of the user to determine that the user is attending a candidate event) to capture audio and video. Surveys may be provided to ask the user to provide the user's impressions about the event and the candidate's performance, and to critique the event and the candidate's performance. Candidates can capture information about their own events easily without hiring professionals, but can utilize some of the many attendees and supporters to collect and publish information. Using push functionality, the app can use the device to request specific actions and/or information be obtained by the user, and the app may provide simple tools and interfaces to make activating the desired functionality (such as photograph, audio and video recording, etc.) easier and automated.

The voter system can also help the voter provide financial support and donations for various entities. The system can allow voters to donate to candidates, pay dues to various organizations and clubs, financially support or oppose various ballot initiatives, support candidate slates, support various Political Action Committees (PAC), provide suggestions and commentary to candidates, ask candidates questions, etc. This can be done in a manner that smart devices are used for making payments, such as by using mobile pay systems, credit cards, ACH payments, wired payments, payment systems, etc. Also, the various data collection capabilities of the smart devices using the apps will be utilized, such as photography, audio recording, video recording, text messaging, social media interactions, web browsing, telephonic communication, geographic location detecting, and other features. The apps may use browsing cookies to determine what information and issues the voters are interested in.

The voter and the candidate can also be provided to send out mass invitations to their contacts, to one or more candidates, party officials, or even to a wider pool of recipients for supporting a candidate, hosting an event or fundraiser, or for other purposes. The central system servers might allow the voter to send out invitations or other messages to voters not currently part of the voter's contact list, to more widely distribute such invitations. In this way, a voter can more actively participate in elections and political activities. The system can also provide these, and other listed, tools and features to third parties involved in the political process and campaigning, such as campaign managers of candidates, party officials, leadership of various clubs and organizations, etc.

Note that these features can also be provided to non-political organizations and their members and leadership. Any type of organization could utilize a system such as disclosed here to recruit members, keep membership informed of organization activities, support organization fundraising, etc. In particular, such a system could be useful for organizations that have a central national entity, and a plurality of regional affiliates, to allow the central and regional groups to communicate and track various activities in diverse locations. In this case, the “voter smart device application” would effectively become a member app, and candidate applications would become leadership or recruiter applications. Some customization of the functionality might be useful, since different types of databases for source material would be utilized, such as regional and central databases, etc.

To support these functions, the voter application executing on a smart device will communicate with one or more external databases and/or remote servers in a centralized system including its own datababases accessible by a plurality of such smart devices executing the installed specialized applications. A separate (or combined-such as by providing an optional candidate module) application could be provided with similar features for the candidates. Other customized applications could be provided with specialized functions, such as for campaign management, party leadership, club leaders, etc.

One design option is to have one or more centralized databases (such as on cloud-based servers and databases that are commercially available), where much or all of this information is collected and stored for access by the smart device installed application. Alternatively, a centralized server may be connected to a number of private and public databases that can be used to retrieve data as desired for providing to the various smart devices upon request (as described in more detail below). A further alternative is that the applications on the smart device might communicate directly with external public and/or private databases and/or commercial databases for retrieving the desired information. It is likely that the most efficient approach would be to centralize as much of the data connections and collection as possible, for provision to the mobile voter application, candidate application, and other applications on an as-requested basis. Although mobile smart devices are most appropriate for the user functions, applications for running on tablets, laptops, and other computers can also be provided (to support Windows, Android, or Apple systems, for example, among others).

The various applications will utilize various features provided by the smart devices, and in particular, mobile device, such as location and direction determination (e.g., GPS, compass, gyroscopes, etc.), communication (e.g., Wi Fi, cellular, Bluetooth, RF, etc.), display, audio, networking (USB, ethernet, serial ports), computing, and other capabilities of the device. The system can utilize various services found in the cloud (e.g., internet/cloud based services). Any of the various remote applications can be customized, as desired, to provide unique features for the particular class of users.

The voter support system including the voter smart device with installed specialized application will utilize voting, voter, geographic (districting), election, and candidate information that can be retrieved from a number of sources, including board of election databases, political party databases, candidate websites and/or databases, commercially available databases, and customized databases that may compile information obtained from other sources, or obtained by the voter system itself (e.g., via surveys, tracked voter activities, etc.) into more useful information. Candidate and other applications will provide the same and/or additional functionality.

The system will support ballot issues and initiatives as well as candidates. Such issues include amendments to state constitutions or city charters, recalls, new statutes, tax levies, zoning issues, and other information. The actual text of such issues can be provided along with endorsements and/or oppositions to such levies. The actual language of any statutory changes can be provided to the voter, along with interpretations and summaries.

Since elections often have candidates running for national, state, county, school district, and/or local city or township positions, the voter application can determine a personalized set of candidates for a particular voter by determining the address of residence of the voter to provide the appropriate and accurate list of all candidates and ballot issues relevant to that particular voter. In other words, the application will show the voter the candidates and issues that should be appearing on that voter's upcoming ballot for voting. Primary, general, and special elections can all be supported. The voter application could have an input screen for the voter to enter his/her home address. Alternatively, the voter application may access other applications such as Google services which often determine the voter's location of residence. Or the voter application may utilize a GPS or other location determining capability of the smart device (particularly mobile devices) to determine the location of the residence of the voter (such as by determining where the device is most often located at night, for example).

Once the voter application (or a program running on a centralized system), know where the voters place of residence is, that information can be used to determine what candidates are relevant for that particular voter. This can be provided as a service of the central server or database, or by retrieving such information from a public database such as a Board of Elections database. Alternatively, such databases might be prepared by local or state or even national political parties for access by the voter application. But using one or more of these sources, the voter app obtains a list of the candidates that will be on that particular voter's ballot.

This list of candidates for which that voter can vote for (including local, state, and national elections) is then provided to the voter, allowing the voter to select one or more of the candidates to find out information about those candidates, such as the information listed above. The list of candidates may be restricted to those running under one or more particular parties. Furthermore, or alternatively, the user may be able to select certain criteria upon which to filter the list of candidates. For example, a proponent of the second amendment right to own guns may set a toggle or flag to show a list of which of the candidates on that voter's ballot support second amendment rights, or are well rated by an organization such as the National Rifle Association (NRA), for example. A toggle might be selected to show candidates who follow certain religions (e.g., are Jewish or Christian or Muslim, for example). Another toggle might be used to show which candidates have raised a substantial amount of money, or who might have particular desirable (or undesirable) particular donors supporting them. Lists of candidate endorsements or opposition may be provided.

In this way, the voter can see a list of candidates that meet particular criteria of interest to the candidate. For example, a Republican voter can get a list of all of the Republicans on a particular ballot, or maybe a list of the Republican candidates endorsed by their local Republican party. The voter application could provide the voter with a slate card of Republican candidates (endorsed or all) for use in the voting booth or to fill out a vote-by-mail ballot, for example.

Since the applications can run on a smart device that can track the location of the user, the voter application can determine where a voter lives and, if the device is mobile, monitor whether the voter has visited the proper voting location for that voter on election day. The voter application can provide notifications to the voter during that day to remind the voter to vote, until the application has determined that the voter has likely voted when it is detected that the voter has visited the voting location. Alternatively or concurrently, the applications might monitor a public or private database that tracks those who have voted, and use that information to determine whether the voter has voted, and use that to issue periodic reminders on election day. When the closing time for the polling location is approaching, but the voter application has not yet detected that the voter likely voted, more urgent reminders might be provided to the voter, and the application might send a message to a party official or the candidate or some other person to let them know that the voter has likely not voted, so that the official or a surrogate can personally contact the voter to encourage the voter to vote.

Similarly, for vote-by-mail (e.g., absentee) voting, the applications can monitor public databases that show who has requested a vote-by-mail ballot, who has been sent a vote-by-mail ballot, and who has returned a vote-by-mail ballot. The applications can issue reminders to the voter to request such a ballot, and once it is determined that a ballot has been sent to the voter, the voter application can remind the voter to return the ballot, until the application is informed that a ballot has been received (such as by checking a public database, or by indication from the voter). The candidate (and other) applications can notify the user of those voters who have requested and/or returned (or not yet returned) vote-by-mail ballots, and those who have voted early or not yet voted. Hence, the applications can help ensure that the voter requests and returns the vote-by-mail ballot in a timely manner and give candidates the ability to access voters who may not yet have voted. If the application determines that the vote-by-mail ballot was likely not properly returned in a timely manner, the application may suggest to the voter that the voter visit the proper polling place for that voter to ensure that the voter gets a vote. Or the system might notify interested individuals or groups, such as a political party or board of election, of the lack of response.

The voter application can also determine, using public databases and records, where the proper voting location for the voter is located and what local candidates and issues are part of particular elections. This is particularly useful because voting locations often change over time. The voting application can display the polling location to the voter, and can be configured to give the voter driving directions to the voting location as well, such as a navigation device or application would do. The voting application might also provide a description of the polling location, when available, to ensure that the voter gets to the proper location. Walking instructions for the latter part of the journey may also be provided. The candidate and other applications may determine locations where voting is heavy, so that candidates can campaign in such locations. Heavy voting determinations might be used by party officials to send additional voter support resources to those locations.

Furthermore, because the system will be used by a large number of people, the system can be designed to include functions that help voters contact other voters having similar interests, and for candidates to identify and contact such voters. Through the use of surveys, and various settings that can capture voter interests and important issues, the system can group voters by areas of special interest, and then help them contact each other by notifying them of others with similar interests.

For example, the application can make a list of voters who value Second Amendment rights to gun ownership, and then provide tools and communication functions to help such voters contact each other. Voters who accept referrals might be referred to organizations that support such rights, such as the National Rifle Association. Issues important to such voters can be tracked, and the voters provided links to information sources.

Furthermore, the system can help voters participate in targeted drives to support or oppose certain issues. Voters can be encouraged to contact legislators about particular legislation, and encouraged to contact newspapers and social media about such matters. Voters might be given the tools to enable knowledgeable communication, such as by providing them with templates for phone calls, or writing opinion pieces or letters to the editors, for example.

The system can also interact with, or replace, various canvassing applications that are available. For example, the application could provide a voter with a set of addresses to visit in support of a particular candidate, issue, or party. The canvasser can be provided with information about a candidate or issue and potentially with survey questions to ask residents. The system can provide a list of targeted voters, such as those with certain party membership, particular interests, hobbies, principles, or group membership. The system can track which addresses the canvasser has visited and the time spent there. Similarly, the system could support voter interaction with other voters by supporting phone functions, texting functions, or other means of voter-to-voter interaction, which may be on behalf of a particular candidate or a party or some other entity or organization. The system can replace various candidate applications used by candidates to canvass neighborhoods and otherwise contact voters directly.

Through efficient targeting of voters, the system can maximize the efficiency and productivity of candidate voter outreach and interaction. The system can match the values of the canvasser with the values of targeted voters. For example, a canvasser who puts a high priority on second amendment rights can be sent to contact voters with similar interests to promote candidates who support those interests.

The voter can also be provided with tools and information to encourage other voters to vote for particular candidates and/or issues. For example, the application might access one or more contact lists of the voter available to the smart device, and send voting reminders to those contacts. Candidate information, including recommendations and endorsements and “vote for” suggestions of the voter himself could be provided to friends and family of the voter. The voter can be provided with the ability to send particular types of information regarding a candidate or issue to others who may share similar interests as the voter. For example, the voter might send messages and information to fellow right-to-life supporters about a particular candidate.

Since the smart device (especially if mobile) with the voter application can track the location of the voter, a voter might be notified when similar types of voters are located nearby. The voter might be informed as to which of his neighbors have similar voting patterns and support similar causes and issues. As the voter walks a neighborhood, the smart device might inform him of households where people have share voter opinions.

The application might also support voter registration efforts. In particular, if the application determines that the voter may have changed residences (e.g., by detecting changed addresses from the external data sources), the application could remind the voter to register to vote at the new address, and the application might provide links or forms to help the voter register electronically.

The application, or specific customized versions of the application, can be configured to support campaigning functions of the candidate and provide support and campaign management tools to the candidates and their management and party officials. It could provide or link to candidate calendars, provide survey results and critiques to the candidate events, provide reports and statistics about the campaign retrieved form public databases, and/or retrieved from system databases based on surveys, user critiques, and candidate monitoring activities. This expanded application can provide opposition materials about opposing candidates for use by the candidates using the application. It can provide contribution tracking, supply campaign templates that may be customizable, support walking lists and direct voter canvassing, manage donations from users of the app or from other donors (by accessing donor databases, for example, to give the candidate up-to-date donor and fundraising information along with campaign account balances. The extended application can support email and texting communications with voters (especially those who are using the system). It can post candidate schedules, give updates to users for changes in candidates schedules, and allow users to suggest candidate events or invite the candidate to events of others. The application can support these functions by tracking candidate schedules and calendars (that may be supported by third party apps such as Google and/or Microsoft and any of their apps such as maps, calendar, collaboration tools, search engines, task tracking, etc.).

The system could also provide staff management functionality to enable candidates and their leadership, or party leadership, to better manage their staff and volunteers. The system can support a candidate requesting for volunteers (a general request or asking specific individuals) to support an event or activity, and get confirmation from the staff or volunteer acceptance of the request. The app can then remind the staff or volunteer about the event and track whether they actually attended the event. The applications can then be used to survey the attendee about the event and what problems occurred or what improvements could be made for future events. The apps might also give the volunteer or staff member the ability to perform an emergency contact of the candidate or a designee or safety authority where help may be needed to respond to a crisis.

The applications can also integrate with other social media platforms, such as Facebook, YouTube, Twitter, Snap Chat, Instagram, TikTok, etc. This allows users to access their own, or candidate or party pages to participate in social media interactions. The applications allow a user to import their Twitter, YouTube, Facebook, and RSS feeds into their app with a touch of a button. Their feed is updated in real-time as the user post, attends events, or responds to surveys or requests for information. Additionally, users may post original content that consists of text, images, or videos. When at a candidate event, the applications can support helping the user post information about the event and the candidate at and during the event, so that the user can provide updates to the social media platform. Hence, the photograph, videography, etc. functions discussed above can be utilized by the applications to post updates on the social media, along with comments by the user about the events. The candidate, or the candidates party, or a third party may be given an ability to modify or delete such posts where they are deemed inappropriate.

The applications can also access various news feeds and other sources of information so that it can display these feeds or provide links to the user to access these feeds. Since the applications have access to various information about the user, the applications can filter such news feeds and other information based on the values, principles, desires, motivations, status, and objectives of that particular user, ensuring that more relevant information is provided to the user. For example, an advocate of the second amendment may have newsfeeds about gun rights prioritized, whereas a mother involved in her children's schooling could have newsfeeds about her local schools priorities.

The applications can be used to publicize local community and government meetings and events that the users might be interested in. Calendars of such events can be provided. Such events might include school board meetings, city council meetings, meetings of various government advisory bodies, legislative meetings, court cases, etc. Typically, such events can be found from public sources that the system can monitor and retrieve information from.

Note that a particularly useful feature of this system is that the system can notify users (e.g., by pushing or popup notices or other means) of many different events and activities, request participation in certain events or activities, request and help the user gather information at and about those events or activities, and determine which events or activities the user has participated in. All this information can be tracked and provided to a central system for use in evaluating both the user and the candidates and their staff and volunteers for effectiveness, consistency, etc.

Also, the data collection and capturing capabilities are very important. The applications on the smart devices track user activities in the pollical arena, and track user responses to requests for information or action. The system gives the user the ability to capture photos and videos of events, determines which events they attended, and monitors what features the user is interested in and what candidates they show the most interest in.

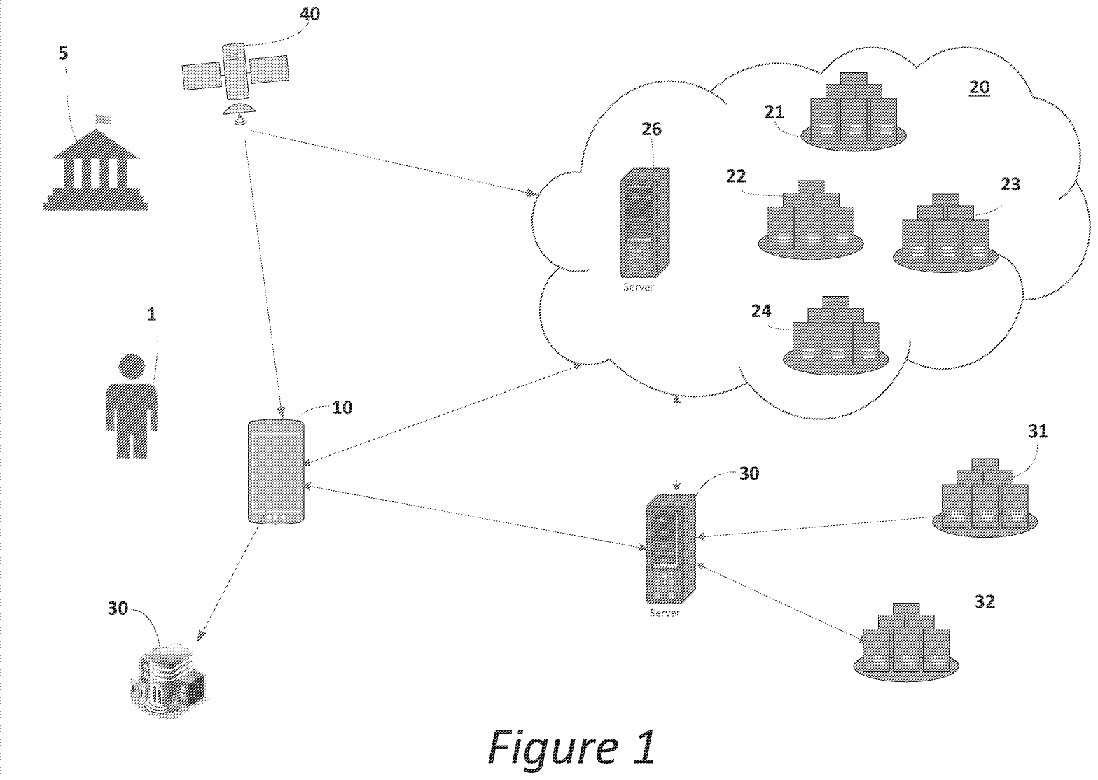

FIG. 1 is a drawing showing various components of an example system and its external connections and data sources. Users 1 using mobile smart device s10 provides the interface between the voter and the system. The voter may travel to the polling location 5 to vote. The smart (e.g. mobile) device 10 may communicate with a remote server 30 of the system, which utilizes one or more databases 31, 32 to store pertinent information. The smart device 10 may also communicate with various entities in the “cloud” 20, including servers 26, and databases 21-24, for example. Such entities in the cloud 20 could be accessed via the Internet using such communications networks as WiFi access points, cellular systems, Bluetooth, etc. Note that the system server 30 and/or the system databases 31, 32 may also be provided in the “cloud” or via a specialized communication pathway such as a dedicated VPN or other means of communication.

The users 1 can be any person that might be a candidate, voter, campaign manager, party official, or any other person using the system as provided herein.

The smart device 10 could be a computer, smart phone, laptop, tablet computer, or other smart device, and in particular a mobile device. In some situations, a fixed location computer may be used for some of the functions of the remote device, but full utilization of the features of the system require a smart device that can be carried by the user (voter), or where at least some mobile component of the remote device is carried by the user (such as a headphone, earpiece, or other device) so long as that mobile component can determine a location of the user (voter). In one embodiment, the smart device application acts mostly as a user interface, with most of the processing and data management and storage being done using the remote server system. The user can be a candidate, political party official, and in particular individual voters.

The user 1 can contact various external entities 30, such as newspapers, legislators, executive branch officers, etc. to communicate needs and desires, such as through the smart device 10 by letter writing, phone calling, etc. The system can support such activities by providing tools and guidelines to the user 1 through the smart device, for example.

FIG. 2 shows the primary functions of the Voter Support System. The system will Determine the Voter Candidate List 110 by determining which candidates will be on the voter's ballot, and displaying those candidates, such as by displaying a Sample Voter Ballot 145, or a slate card, or just a list of such candidates. This list may be filtered according to the accepted Voter Filter Criteria 132 or the Voter Candidate Priority List 131 that the system has accepted from the voter via an interface screen provided on the smart device (for example, it might provide the slate of Republican candidates, or those who support second amendment values, etc.). The system can then display candidate meeting filter criteria 146 to the voter.

The system might also provide an ability to communicate voter requests and information to the candidates 151, and display candidate contact information 147 so that the voter can send questions to the candidate, and/or request information. This capability may be provided on an optional basis, such as when a candidate has opted into such interaction directly with voters. The communication could be done via texting, instant messaging, email, or some other means.

The system can also request that the user participate in voter surveys 152, in which case the system will collect voter answers to survey questions and use that information to aid candidates, political parties, and/or government agencies or others in supporting the election process.

The system will also determine device locations 111 in order to monitor the location of the voter, such as to determine where the voter's residence is located, and/or to determine whether the voter has visited a polling location to vote on election say. The device will determine the correct voter voting location 112 based on the voter's residence by retrieving the voting location information 120 and election information 123 from the system database or by accessing the information from a public source, such as a Board of Election.

The system can also Retrieve Political and Candidate Event Information 121 by accessing the system database, or by accessing other information sources (such as candidate information databases). This may be done in response to the smart device Accepting Voter Candidate Information Requests 130 using a user interface provided by the application on the smart device. Such information might also be provided if the voter requests to be informed of other event or political activities.

The system can also retrieve candidate information 122 about the candidate upon request of the voter (such as by the user clicking on a link in a candidate list or otherwise requesting the information via a user interface on the remote device via inputting Accepting Voter Candidate Information Requests 130) to display candidate information 142, display candidate event schedules 144. The device can display voter notifications 140 to the voter to remind the voter of events, voting requirements, etc.

The smart device can also accept voter volunteer request acceptance 133 from the voter, which means that the voter is volunteering to participate in some activity, like attending a rally or event, working at polling locations, collecting signatures, campaigning for a candidate (by walking, dropping literature, making phone calls, etc.), or other volunteer activities. The system can display political events and rallies 141 and accept reservations to such events for voter participation. The system can add such events to the voter's calendar, and periodically remind the voter of the event. The smart device will then display volunteer activity requests 143 to the voter in a list, on a calendar, or via a notification.

Via a user interface, the smart device will display options, and then accept voter data sharing criteria 134 regarding data policies the voter accepts. The voter may prohibit the application from sharing any gathered information with external entities, or limit such information dissemination. Limits on voter location tracking, and other personal information can also be provided as an option.

The system can notify external entities of voter voting status 153, such as whether the voter has voted at his polling location or whether the voter has returned his vote-by-mail ballot, so that those external entities can update records and perhaps remind the voter to vote.

Note that the system, such as via the application running on the smart device, will be able to install and update 160 the application in a regular manner.

These various functions, among others, will be executed using various software modules running on the smart device, the remote server, or both.

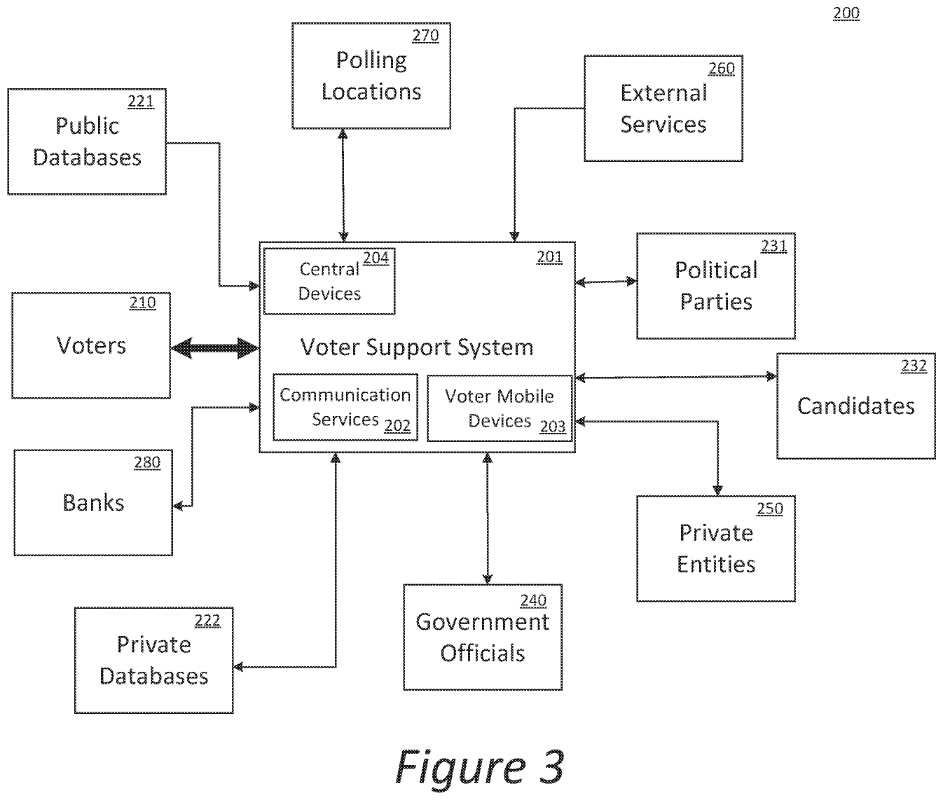

FIG. 3 shows a generalized view of the universe 200 of an example system 201. The system 201 utilizes various communications services 202 that are provided by the smart device and system servers, such as cellular networks, cloud services, etc. The system 201 interacts extensively with a plurality of voters 210, each of whom is utilizing it's own smart (e.g., mobile) computing device 203 that is “utilized” by the system 201 when executing the voter application installed on the smart device. Centralized devices 204 remote from the mobile devices, including one or more servers and/or databases, support the system with data storage and computing capabilities. Increasing the centralized capabilities 204 decreases the burden that must be put on the smart devices 203, with the overall functionality being provided by the interaction of these two subsystems.

The system 201 will interact with many external entities, as discussed above. The system 201 will utilize public databases 221 (such as voter rolls, voting records, polling locations, voting districts, public demographic databases, etc.) and private databases 222 (such as organization memberships and subscriptions, private demographic databases, shopping patterns, etc.). The system will interact with one or more political parties 230 to both receive and share voter information and candidate and issue information along with interactions with candidates 232 and their campaigns as well. The system 201 can interact with various government officials, 240, including election officials, legislators, executive branch elected and appointed officials, mayors, school boards, city council members, etc.

The system 201 can also interact with many different private entities 250, such as non-government organizations (NGOs), think tanks, non-profits, data collection businesses, clubs, service organizations, unions, political action committees (PACs) etc. The system 201 will also utilize various external services 260, such as GPS, cellular systems, Wi Fi systems, etc. Such external services might include social media platforms like Twitter and Facebook, for example, to allow the Voters 210 to participate in those platforms. And the system 201 will be used to help the voter locate and vote at the polling locations 270, while determining when the voter visits these locations and has therefore likely voted.

The voter system 201 can also be utilized for fundraising activities. The system can interact with various banks 280 for both receiving and send donations as directed by the voters. The voter may contribute donations to candidates, pay dues to political parties, contribute to NGOs or other non-profits, purchase materials from businesses, donate to PACs, etc. all by utilizing various payment functionalities available on the smart devices.

As discussed above, the system 201 is comprised of smart devices (or personal computers) of the voters. These smart devices are general purpose devices, in particular mobile devices, including processors and memory for executing software applications. The software application utilizes the smart device for providing specialized functions based on the software code. This application might be downloaded from cloud-based application repositories like Google Play or the Apple app store, for example.

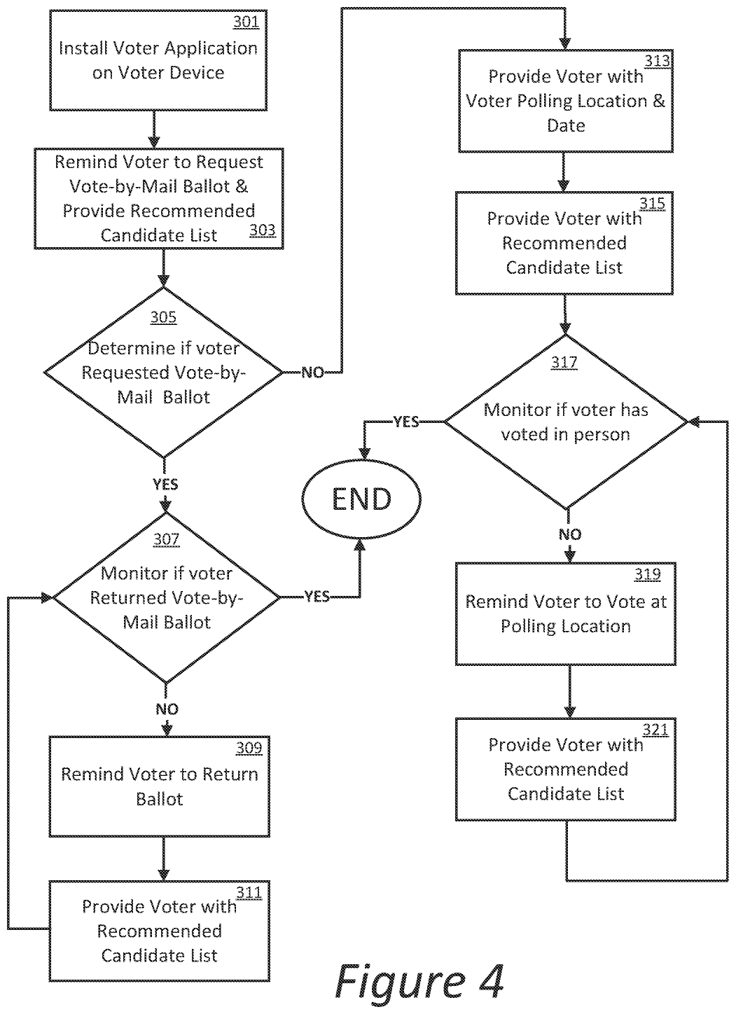

FIG. 4 provides a flow chart of an example voter support process to aid voters in voting in elections. To utilize the process, the system utilizing a computerize electronic device of a particular voter (such as a smart phone, tablet, computer, etc.). The voter allows an application to be installed on the phone 301 so that the voter voting activity can be tracked and to allow the voter to be messaged, as discussed in more detail hereinabove.

The application then interacts with the Voter Support System (the “System”, for example, as shown in the example system 201 of FIG. 3 and described herein) via the voter's personal device to implement this voter support process. A personal device, such as a mobile smart device, is particularly useful since it is mobile and can be carried by the voter to support voter navigation and so that the voter can take recommendation lists into polling locations, for example.

The process of FIG. 4 is intended to ensure that the voter votes in an election. First, the process reminds the voter, via the voters personal device, to request a vote-by-mail ballot 303. It is often strongly suggested to voters that they vote by mail in case something would interfere with their voting in person and hence prevent them from voting at all. The system can support this vote-by-mail request by providing links or forms to the voter that enable the voter to request to vote-by-mail, utilizing the voter's personal device. For example, the voter may be given a link to a form or website where the voter can request such a ballot.

The system is configured to determine if and when the voter has requested a vote-by-mail ballot 305, such as by monitoring voter information websites or other public databases such as may be found at a Board of Elections site (as described hereinabove) to obtain current voter election information that includes the status of the voter for the particular election. If the system determines that the voter has requested to vote-by-mail, it can monitor if and when that ballot has been mailed to the voter. Alternatively, in some states, the system cannot determine if the voter requested such a vote-by-mail ballot (except by recording if the voter used the system to help request such a ballot). In this case, the system monitors the public database to determine if and when a vote-by-mail ballot has been sent to the voter.

Once it is determined that a vote-by-mail ballot has been sent to the voter, the system monitors whether the voter has returned the vote-by-mail ballot 307 by monitoring public voter databases. At regular intervals (such as daily, or weekly or monthly), the system will send out a reminder to the voter to return the ballot 309 via messaging using the voter application on the voter's personal device. The voter can also be provided with a list of recommended candidates 311 for use in filling out the ballot. Such recommendations might include a listing of endorsed candidates, a sample ballot that is filled out, candidate advertising, etc. Note that such recommendations can also be sent at other times, such as prior to the voter requesting the vote-by-mail ballot.

The steps 307, 309, and 311 are then looped until it is determined that the voter has returned the vote-by-mail ballot. Note that if by election day the voter has still not been determined to have returned the vote-by-mail ballot, the system can encourage the voter to vote in person by proceeding to step 313.

Again, this process of steps 307, 309, and 311 loops to send regular notices to the voter to return the ballot such that the voter gets regular reminders (e.g. daily, weekly, or monthly) to help ensure that the voter returns the ballots. The recommended candidate list (and/or recommendations on how to vote on ballot issues, etc.) is provided to support particular candidates chose by the operators of the system, or by some third party, such as a political party or other organization (e.g., union, voter organization, club, etc.).

This recommended candidate list can be based on the location of the voter, so that the list is customized to the voter's ballot, including local candidates and local issues. This can be determined by the voter's address, which can be input by the voter into the personal device or determined from public records. The voter's personal candidate and issue list can typically be obtained from public databases, such as local Boards of Election or the state Board of Election, for example. In this way, the recommendations provided to the voter can include all levels of voting, from national to local issues and candidates.

After determining that the voter has returned the ballot, the voter application might also provide the voter with a survey to ask for inputs as to how the voter voted, such as which candidates the voted for or what the voted on particular issues.

At step 305, if it is determined that the voter has not requested a vote-by-mail ballot (e.g., when the requesting period has ended or at some point in time-such as a day, a week, or two or more weeks before the date of the election), the system now goes into the process of encouraging the voter to vote in person. Note that the system may determine that the voter is not requesting a vote-by-mail ballot through some response by the voter (such as an input indicating as such, or through historical analysis, or some other method). Voters might also indicated affirmative by response using the personal device that they intend to vote in person.

Once the system transitions to encouraging an in-person vote, the system can provide the voter with a voter polling location and date 313. This can be determined based on the voter's address from information available in public databases, such as the voter's precinct information. In this way, the voter application on the voter's personal device can not only indicate where the polling is located, but could interact with map software to provide directions to the voter to help navigate the voter to the poll when desired. Such navigation might be enabled by input request into the personal device by the voter, for example, and would be done on voting day (or another day if the voter is voting in person for early voting—in fact, the system might encourage early voting in a similar manner to ensure the voter gets to vote).

Again, the voter can be provided with a recommended candidate (and/or ballot issue) list 315. This list can be printed using the voter app, or it can remain on the voter's personal device for use and reference during the voting process.

The system will then monitor whether the voter has voted in person 317 (whether on election day, or by early voting), by monitoring when the voter has entered a proper polling location, such as using a GPS function of the voter's personal device to determine if the voter has gone to the GPS coordinates of the voting location. When the voter has entered the designated voting location, it can be assumed that the voter is there to vote, and a reminder of the recommended candidates might be again provided to the voter. To verify that the voter has voted, the voter application on the personal device might ask the voter if the voter has voted, or display a congratulations on voting message with an input for the voter to deny that the voted, etc. The voter application might also provide the voter with a survey to ask for inputs as to how the voter voted, such as which candidates the voted for or what the voted on particular issues.

So long as the system determines at step 317 that the voter has not yet voted in person, the system will regularly (daily, hourly, etc.) remind the voter to vote at his or her designated voting location 319, and can also provide the voter again with the list of recommended candidates (and/or issues) 321. The system loops through steps 317, 319, and 321 regularly (such as daily for early elections or hourly on election day) until either the election date has expired, or it is determined that the voter has voted in person (or it is determined that an absentee ballot has been obtained from the voter).

Accordingly, the example process of FIG. 4 is used to encourage and aid the voter in voting, and monitor the voter's progress in voting. This process can be combined with the other features described above, such as supporting individual candidates or political parties or the objectives of other organizations.

Note that the system disclosed herein can be used with smart targeting systems or organizations to target particular voters based on their personal information, which may include political party; voting history; club membership; organization members; political beliefs and principles; location; polling results; focus group results; magazine subscriptions; ethnicity and gender; sexual orientation; product ownership (including automobiles and appliances); shopping history; social media membership and participation and postings; family status, size, and type; personal philosophy; religion (or lack thereof); children status including schools attended; education level (drop out, HS diploma, bachelor degree, masters degree, doctorate, professional degree); profession, driving record, criminal history; history of residences; books read; pet ownership; lifestyle; restaurants patronized; medical history; age; marital status; online activity (including websites visited); current medical condition(s); job history; and other personal information that can help determine and influence how a person votes. Such information can be collected from public and/or private sources, by using polling and focus groups, and other means.

These smart targeting systems can utilize the above information to target voters that will likely vote in a particular way desired by the operators of the system. For example, the system can identify voters of any party who might support particular candidates and/or issues. Cross-party (e.g., Democrats and Republicans) voting potential can be identified and exploited. The system can utilize these targeting systems to encourage desired voters to install the voter application(s) and follow the desired procedures. For example, QR codes can be provided to voters via text messaging, mailed materials, handouts or business cards distributed at events, websites, etc. which connect the user to sources of the applications for installation on their own personal (and hopefully mobile) smart devices.

Campaigns to recruit voter participation can be performed by any interested individual or group, such as candidates, political parties, clubs, organizations, campaigns, etc. The system can be designed to offer such individuals or groups use of the system in return for payment. The various features of the system can be customized to the individual or organization, such as by using logos, trademarks, and other features that customize the view and materials provided to the desired voters. Users of the system can be purged from the system (such as by disabling or uninstalling the voter applications) if they don't exhibit the desired behavior, such as if their behavior has changed or the initial assessment of the user was erroneous in its conclusions.

This specialized application of the smart device is configured to utilize various features of the smart device (such as displays, audio, microphones, networking applications, GPS, keypads, etc.) to interact with the voter by providing user interfaces for both providing information to the user (by display, audio, etc.), and to receive information and commands from the user (by a microphone, keyboard, keypad, touchscreen, or other input devices). The application utilizes communication functions of the smart device to which communicate with a central server system that can include one or more computers, storage devices, and databases. This server system can directly interact with various external entities (as shown in the example of FIG. 3), and can be programmed to provide the primary processing functionality of the system by collecting, collating, and transforming the collected information into useful voting information for providing the above described services to the user (voter).

The division of functionality between the smart device and the server system is somewhat arbitrary, and can be varied based on the desired efficiencies and hardware involved.

Note that although this process is described focusing on supporting the voting process for elections, this process can also be utilized for other purposes. Whenever an organization or business needs to monitor an activity of a customer or worker to perform a particular task, in particular by a due date, and in particular when there may be more than one way of performing the task (e.g., in person vs. remotely), this system can be utilized to monitor whether and when the activity has been performed, provide regular reminders to perform the activity until it has been accomplished, and providing alternative means of performing the activity if it has not been performed by another particular means.

All that is needed is the capabilities of: determining when the person has been assigned the activity, determining whether the person has performed the activity, and notifying (e.g., reminding) the person to complete the activity. This tends to require some type of system and database (which may be internal or external) that monitors and collects information about the person regarding the activity. Commonly used task assignments and monitoring systems, docketing systems, and even commercial web usage tracking systems (such as using cookies, for example) could be utilized for such purposes. The invention is particularly useful when the performance of the task includes at least an option of someone visiting a particular location to complete a part of the task. For example, in a legal proceeding, a clerk might travel to a courthouse to file a legal document, an convict might need to check in with a parole officer at a particular location, or a driver might travel to a Bureau of Motor Vehicles to take a driving test to obtain a license or discharge a limitation. In these, and many other similar situations, the invention could be effectively utilized to ensure that the desired activity (e.g., task) is completed.

As will be appreciated by one of skill in the art, the example embodiments may be actualized as, or may generally utilize, a method, system, computer program product, or a combination of the foregoing. Accordingly, any of the embodiments may take the form of an entirely hardware embodiment, an entirely software embodiment (including firmware, resident software, microcode, etc.) for execution on hardware, or an embodiment combining software and hardware aspects that may generally be referred to herein as a “system.” Furthermore, any of the embodiments may take the form of a computer program product on a computer-usable storage medium having computer-usable program code embodied in the medium.

As described above, the system can utilize mobile smart devices such as smartphones, tablets, smart watches, etc.

Instead of installing specialized applications on the smart devices, the system can alternatively be configured such that it utilizes existing applications that might already be installed on the smart device, negating the need for installation of specialized applications. In such a situation, the existing software, such as a web browser, for example, would access the functions described herein regarding the smart device application via browser functions that utilize either locally installed apps and plug ins, or that execute the functions on the centralized servers, such as in the cloud.

For example, any, much, or all of the functionality described for the installed applications hereinabove could instead be provided via a web interface that accesses computing resources of the centralized server(s) and database(s). The web interface would provide the desired user interfaces without requiring the user to install specialized applications (which instead would be executed remotely). This avoids the need for the user to install a new application on the smart device. Since since at least some users may be wary of installing third party applications on their smart devices, this alternative addresses those concerns. Another solution is to provide both options, so that users can install a specialized application if they prefer, or alternatively could access all or at least some of the functionality via a web interface.

Any suitable computer usable (computer readable) medium may be utilized for storing the software for executing on the various computing devices (including servers, mobile applications, etc.). The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, electronic disk, a random access memory (RAM), a read-only memory (ROM), an erasable programmable read-only memory (EPROM, EEPROM, or Flash memory), a compact disc read-only memory (CDROM), or other tangible optical or magnetic storage device; or transmission media such as those supporting the Internet or an intranet. Note that the computer usable or computer readable medium could even include another medium from which the program can be electronically captured, via, for instance, optical or magnetic scanning for example, then compiled, interpreted, or otherwise processed in a suitable manner, if necessary, and then stored in a computer memory of any acceptable type.

In the context of this document, a computer usable or computer readable medium may be any medium that can contain, store, communicate, propagate, or transport the program for use by, or in connection with, the instruction execution system, platform, apparatus, or device, which can include any suitable computer (or computer system) including one or more programmable or dedicated processor/controller(s). The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the example embodiments may be written by conventional means using any computer language, including but not limited to, an interpreted or event driven language such as BASIC, Lisp, VBA, or VBScript, or a GUI embodiment such as visual basic, a compiled programming language such as FORTRAN, COBOL, or Pascal, an object oriented, scripted or unscripted programming language such as Java, JavaScript, Perl, Smalltalk, C++, Object Pascal, or the like, artificial intelligence languages such as Prolog, a real-time embedded language such as Ada, or even more direct or simplified programming using ladder logic, an Assembler language, or directly programming using an appropriate machine language.

Examples of various embodiments may be described with reference to flowchart illustrations and/or block diagrams of methods, apparatus (systems) and computer program products according to the various embodiments. The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It will be understood that each block of the flowchart illustrations and/or block diagrams, and combinations of blocks in the flowchart illustrations and/or block diagrams, can be implemented by computer program instructions. These computer program instructions may be provided to a computing device including one or more processors of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions. The organization of such charts is for descriptive purposes for ease of communication, whereas the actual organization of the software code for some embodiments may utilize any of many different organizational structures that may differ substantially from the exmaples.

The computer program instructions may be stored or otherwise loaded in a computer-readable memory that can direct a computing device or system, or other programmable data processing apparatus, to function in a particular manner, such that the instructions stored in the computer readable memory produce an article of manufacture including instruction means which implement the function/act specified in the flowchart and/or block diagram block or blocks.

The software comprises computer program instructions that are executed by being provided to an executing device or component, which can include a processor of a general purpose computer, a special purpose computer or controller, or other programmable data processing apparatus or component, such that the instructions of the computer program, when executed, create means for implementing the functions/acts specified in the flowchart and/or block diagram block or blocks. Hence, the computer program instructions are used to cause a series of operations to be performed on the executing device or component, or other programmable apparatus to produce a computer implemented process such that the instructions which execute on the computer or other programmable apparatus the steps for implementing the functions/acts specified in this disclsure. These steps or acts may be combined with operator or human implemented steps or acts and steps or acts provided by other components or apparatuses in order to carry out any number of example embodiments of the invention.

Finally, it is noted that although the examples given above all pertain to elections to public office and governance matters, the system could also be utilized by other relatively large organizations for supporting organization governance. For example, charity organizations might interact with donors using such applications. Organizations with large boards of directors could use such a system to help perform organization governance. Private or even public corporations might use such a system to keep their stockholders informed and to perform corporate governance functions. Schools and universities might use such a system to engage their alumni, students, and other stakeholders. Other potential uses are also contemplated.

The terminology used herein is for the purpose of describing example embodiments only and is not intended to be limiting. As used herein, the singular forms “a”, “an” and “the” are intended to include the plural forms as well, unless the context clearly indicates otherwise. It will be further understood that the terms “comprises” and/or “comprising,” “including,” “having,” “containing,” when used in this specification, specify the presence of stated features, integers, steps, operations, elements, and/or components, but do not preclude the presence or addition of one or more other features, integers, steps, operations, elements, components, and/or groups thereof.

Although specific example embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of reminding a voter to vote in a particular election, comprising the steps of:
a computer system retrieving, from an external database, current voter election information about a particular voter regarding the particular election;
the computer system determining, from said current voter election information, whether the voter has not yet submitted a vote in the particular election; and
if said voter has not already submitted a vote in the particular election, the computing system sending to a device of the voter via a communication network a reminder message to the voter to vote in the particular election.

2. The method of claim 1, wherein said current voter election information includes information indicating that the particular voter requested a vote-by-mail ballot.

3. The method of claim 2, wherein said current voter election information also includes information used for determining that the particular voter has not yet returned said vote-by-mail ballot.

4. The method of claim 3, wherein said reminder message includes a message reminding the voter to return said vote-by-mail ballot.

5. The method of claim 4, wherein said reminder message also includes a message recommending to the voter to vote for one or more candidates and/or issues.

6. The method of claim 4, further comprising the steps of repeating sending said message reminding the voter to return said vote-by-mail ballot at regular intervals until it is determined that the voter has returned said vote-by-mail ballot.

7. The method of claim 6, further comprising the step of determining when election day is near or has arrived without said voter returning said vote-by-mail ballot; and when it is so determined, the computer system notifying the voter of the location of a polling place for voting in person.

8. The method of claim 1, wherein said current voter election information includes information indicating that the particular voter has not requested a vote-by-mail ballot.

9. The method of claim 8, wherein said current voter election information also includes information used for determining the proper location for the particular voter to vote in person for the particular election, and wherein said message includes a message notifying the particular voter of said proper location.

10. The method of claim 9, wherein said message also includes a message recommending to the voter to vote for one or more candidates and/or issues.

11. The method of claim 9, further comprising the step of monitoring a location of the device of the voter for use in determining if the voter has visited the proper location.

12. The method of claim 11, further comprising the steps of regularly sending a message to the device of the voter reminding the voter to vote at said proper location until it is determined that the voter has visited the proper location or that the election period is over.

13. The method of claim 1, further comprising the step of reporting when the voter has voted in the particular election by sending a message to an external entity.

14. The method of claim 1, further comprising the step of reporting when the voter has voted in the particular election by sending a message to a political party.

15. The method of claim 1, wherein said reminder message includes a link to information about a particular candidate or issue in the particular election.

16. The method of claim 1, further comprising the step of providing a link to the particular voter enabling the voter to request a vote-by-mail ballot.

17. The method of claim 1, wherein said external database is a database provided by a government entity.

18. A method of reminding a voter to vote in a particular election, comprising the steps of:
a computer system retrieving, from an external database, current voter election information about a particular voter regarding the particular election;
the computer system determining if the voter has received a vote-by-mail ballot from said current voter election information, and if the voter has received a vote-by-mail ballot, the computer system monitoring, based on said current voter election information, if the voter has returned the vote-by-mail ballot;
the system determining if the voter is not likely to have returned the vote-by-mail ballot, and if the system determines that the voter is not likely to have returned the vote-by-mail ballot, the system sending the voter a message including an appropriate location for the voter to vote in person.

19. The method of claim 18, further comprising the step of, if the system sent the voter the message including an appropriate location for the voter to vote in person, regularly reminding the voter to vote in person at the appropriate location until the system determines that the voter has voted in the election or until the election is over.

20. The method of claim 18, further comprising the step of the computer system sending voter a message recommending to the voter to vote for one or more candidates and/or issues.

21. A method of reminding a voter to vote in a particular election, comprising the steps of:
a computer system retrieving, from an external database, current voter election information about a particular voter regarding the particular election;
the computer system sending a message to a voter computing device of the particular voter suggesting that the particular voter request a vote-by-mail ballot;
the computer system providing a link to the particular voter enabling the voter to request a vote-by-mail ballot;
the computer system detecting whether the voter has requested the vote-by-mail ballot;
the computer system sending a message to the voter recommending to the voter to vote for one or more candidates and/or issues;
if the voter requested a vote-by-mail ballot, performing the steps of:
the computer system determining whether the voter has returned the vote-by-mail ballot, and
until the computer system has determined that the voter has returned the vote-by-mail ballot, the computer system regularly sending a message to the voter computing device reminding the voter on a regular basis to return the vote-by-mail ballot; and
if the voter has not requested a vote-by-mail ballot, performing the steps of:
the computer system sending a message to the voter computing device indicating a location where the voter can vote in person, and
the computer system determining whether the voter has voted in person, such that if it is determined that the voter has not yet voted in person, the computer system regularly reminding the voter to vote in person until it is determined by the computer system that the voter has voted in person or until the election is over.

22. The method of claim 20, wherein said computer system determines that the voter has not yet voted in person by determining whether the voter has visited a polling location appropriate for the voter.
